(19) United States
(12) Patent Application Publication
(10) Pub. No.: US 2026/0085749 A1
(43) Pub. Date: Mar. 26, 2026

(54) DIFFERENTIAL DEVICE

(71) Applicant: TOYOTA JIDOSHA KABUSHIKI KAISHA, Toyota-shi (JP)

(72) Inventor: Yasuhiro MIYAMOTO, Togo-cho (JP)

(73) Assignee: TOYOTA JIDOSHA KABUSHIKI KAISHA, Toyota-shi (JP)

(21) Appl. No.: 19/339,904

(22) Filed: Sep. 25, 2025

(30) Foreign Application Priority Data
Sep. 25, 2024 (JP) 2024-166611

(51) Int. Cl. F16H 48/22; F16H 48/30

(52) U.S. Cl. CPC F16H 48/22; F16H 2048/305

(57) ABSTRACT

A differential device includes: (a) an input rotary member; (b) a pair of output rotary members; (c) a clutch for limiting rotations of the pair of output rotary members relative to each other; (d) a pressing member for pressing the clutch so as to cause the clutch to generate a torque that limits the rotations of the pair of output rotary members relative to each other; (e) an elastic member for applying a preload to the clutch such that the clutch generates an initial torque; (f) an adjuster for pressing the elastic member so as to cause the elastic member to apply the preload to the clutch and to change the preload; and (g) a fixture which is configured to fix the adjuster to a non-rotatable member so as to make the adjuster unrotatable relative to the non-rotatable member, and to release fixing of the adjuster to the non-rotatable member.

This application claims priority from Japanese Patent Application No. 2024-166611 filed on Sep. 25, 2024, the disclosure of which is herein incorporated by reference in its entirety.

### FIELD OF THE INVENTION

The present invention relates to a differential device having a mechanical differential limiting mechanism.

### BACKGROUND OF THE INVENTION

There is well-known a differential device including an input rotary member to which a power is to be inputted, and a pair of output rotary members to which the power inputted to the input rotary member is to be distributed, such that the pair of output rotary members are allowed to be rotated relative to each other in a differential state of the differential device, and such that the pair of output rotary members are to be rotated integrally with the input rotary member in a non-differential state of the differential device in which the pair of output rotary members are to be rotated at the same rotational speed. For example, a differential device including a clutch as a mechanical differential limiting mechanism described in Patent Document 1 is such a differential device. This Patent Document 1 discloses an initial-torque adjustment mechanism capable of adjusting an initial torque of the clutch.

### PRIOR ART DOCUMENT

### Patent Document

[Patent Document 1]
Japanese Utility Model Application Laid-Open No. H05-61547

### SUMMARY OF THE INVENTION

The initial-torque adjustment mechanism described in Patent Document 1 has complicated structure and operation method. For example, the initial-torque adjustment mechanism includes a flange which protrudes outside a differential casing and which is disposed on a drive shaft, a nut which is housed in the flange and is screwed to an end portion of the drive shaft, a disc spring and the like which are disposed between the nut and the flange. Further, when the nut in the flange is to be operated to adjust the initial torque, a joint, to which an axle on side of a tire is connected and which is attached to an opening of the flange, may be an obstacle, and the flange and the joint may need to be separated.

The present invention has been made in view of the above circumstances, and an object of the present invention is to provide a differential device which has a simplified construction required for adjusting an initial torque of a clutch, and which makes it possible to easily adjust the initial torque.

The present invention provide a differential device includes: (a) a casing; (b) an input rotary member which is fixed to the casing and to which a power is to be inputted; (c) a pair of output rotary members to which the power inputted to the input rotary member is to be distributed, such that the pair of output rotary members are allowed to be rotated relative to each other in a differential state of the differential device, and such that the pair of output rotary members are to be rotated integrally with the input rotary member in a non-differential state of the differential device; (d) a clutch which is housed in the casing, and which is configured to limit rotations of the pair of output rotary members relative to each other, by connecting the pair of output rotary members with the casing; (e) a pressing member which is housed in the casing, and which is configured to press the clutch so as to cause the clutch to generate a torque that limits the rotations of the pair of output rotary members relative to each other; (f) an elastic member which is housed in the casing, and which is configured to apply a preload to the clutch such that the clutch generates an initial torque that is an initial magnitude of the torque; (g) an adjuster which is screwed to the casing, and which is configured to press the elastic member so as to cause the elastic member to apply the preload to the clutch and to change the preload with an amount of screwing of the adjuster being changed; and (h) a fixture which is configured to fix the adjuster to a non-rotatable member so as to make the adjuster unrotatable relative to the non-rotatable member, and to release fixing of the adjuster to the non-rotatable member.

In the differential device according to the present invention, there are provided the clutch, the pressing member and the elastic member, which are housed in the casing, the adjuster screwed to the casing, and the fixture configured to fix the adjuster to the non-rotary member so as not to be rotatable relative to the non-rotary member and to release the fixing. The clutch is a mechanical differential limiting mechanism. The pressing member is a member configured to press the clutch so as to cause the clutch to generate a torque that limits rotations of the pair of output rotary members relative to each other. The elastic member is a member configured to apply the preload to the clutch so as to generate an initial torque. The adjuster is configured to press the elastic member so as to change or adjust the preload with an amount of screwing of the adjuster being changed or adjusted. Accordingly, in a state in which the adjuster is fixed through the fixture so as not to be rotatable relative to the non-rotatable member, the casing is rotated integrally with the output rotary members by, for example, rotating the pair of output rotary members in the same direction at the same rotational speed. When the casing is rotated, the screwing of the adjuster in a non-rotating state is tightened or loosened relative to the casing, so that the preload applied to the clutch by the elastic member is changed, and the initial torque of the clutch is changed or adjusted. The adjustment amount of the initial torque can be controlled by rotation amount of the output rotary members. When the initial torque of the clutch is not be changed or adjusted, the fixing of the adjuster by the fixture is released.

Therefore, the differential device has a simplified construction required for adjusting the initial torque of the clutch, and makes it possible to easily adjust the initial torque.

### BRIEF DESCRIPTION OF THE DRAWINGS

FIG. 1 is a view schematically showing a construction of a vehicle including a differential device to which the present invention is applied;

FIGS. 2A and 2B are cross sectional views showing, by way of example, a construction of the differential device according to an embodiment of the invention, wherein FIG. 2A shows an overall of the differential device, and FIG. 2B shows a part of the differential device, which is for applying a preload to a clutch;

FIGS. 3A and 3B are views for showing, by way of example, an initial adjustment mechanism in the embodiment, wherein FIG. 3A shows a relative positional relationship between a differential casing and the initial adjustment mechanism, and FIG. 3B is a perspective view of the initial adjustment mechanism;

FIGS. 4A and 4B are views showing, by way of example, an initial-torque adjustment procedure in the differential device according to the embodiment of the invention, wherein FIG. 4A shows a state of the initial adjustment mechanism when an initial torque is being adjusted, and FIG. 4B shows a state of the initial adjustment mechanism when the vehicle is running;

FIG. 5 is a view showing, by way of example, an adjustment of the initial torque in the differential device according to the embodiment; and

FIGS. 6A and 6B are views showing, by way of example, an adjustment of an initial torque in a differential device of a comparative example, wherein FIG. 6A schematically shows a construction of the differential device provided with an initial-torque adjustment mechanism in the comparative example, and FIG. 6B schematically shows a construction of the initial-torque adjustment mechanism in the comparative example.

### DETAILED DESCRIPTION OF PREFERRED EMBODIMENT

Hereinafter, an embodiment of the present invention will be described in detail with reference to the drawings.

### EMBODIMENT

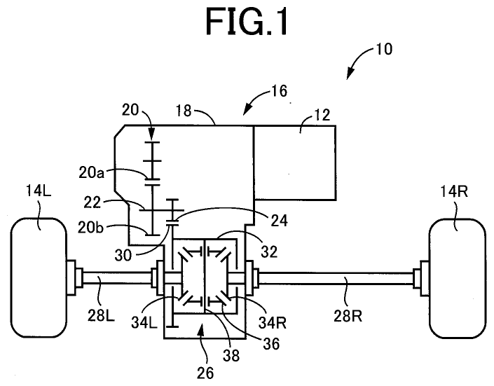

FIG. 1 is a view schematically showing a construction of a vehicle 10 including a differential device 26 to which the present disclosure is applied. As shown in FIG. 1, the vehicle 10 includes a power source 12, left and right drive wheels 14 and a power transmission device 16 provided in a power transmission path between the power source 12 and the drive wheels 14. The power source 12 is, for example, an engine as a known internal combustion engine. As the power source 12, for example, an electric motor as a known rotating electric machine may be used in addition to or instead of the engine. The drive wheels 14 include a left drive wheel 14L and a right drive wheel 14R. The “right and left” are right and left with respect to the forward direction of the vehicle 10.

The power transmission device 16 includes a housing 18, a counter gear mechanism 20, a counter shaft 22, a final gear 24 and a differential device 26, such that the counter gear mechanism 20, the counter shaft 22, the final gear 24 and the differential device 26 are provided in the housing 18. The housing 18 is a member attached to a body of the vehicle 10 so as to be unrotatable relative to the body of the vehicle 10. The housing 18 corresponds to “non-rotary member” recited in the appended claims. The power transmission device 16 includes left and right drive shafts 28 connected to the differential device 26. The counter gear mechanism 20 includes a pair of gears consisting of a drive gear 20a and a driven gear 20b that meshes with the drive gear 20a. The drive gear 20a is connected to the power source 12, for example, directly or through a gearbox (not shown) or the like. The driven gear 20b is connected to the final gear 24 through the counter shaft 22. The final gear 24 meshes with a differential ring gear 30 of the differential device 26. The drive shafts 28 include a left drive shaft 28L and a right drive shaft 28R. Each of the drive shafts 28 connects the differential device 26 and a corresponding one of the drive wheels 14. The power transmission device 16 is configured to transmit a power from the power source 12 to the drive wheels 14.

The differential device 26 includes, in addition to the differential ring gear 30, a differential casing 32, left and right differential side gears 34, a pair of differential pinions 36 and a pinion shaft 38. The differential ring gear 30 is integrally connected to an outer surface of the differential casing 32. The differential ring gear 30, which is fixed to the differential casing 32 and to which the power of the power source 12 is to be inputted, corresponds to “input rotary member” recited in the appended claims. The differential casing 32 is supported by the housing 18 through a bearing (not shown) so as to be rotatable relative to the housing 18. The differential casing 32, which houses the differential side gears 34, the differential pinions 36, the pinion shaft 38 and the like, corresponds to “casing”recited in the appended claims.

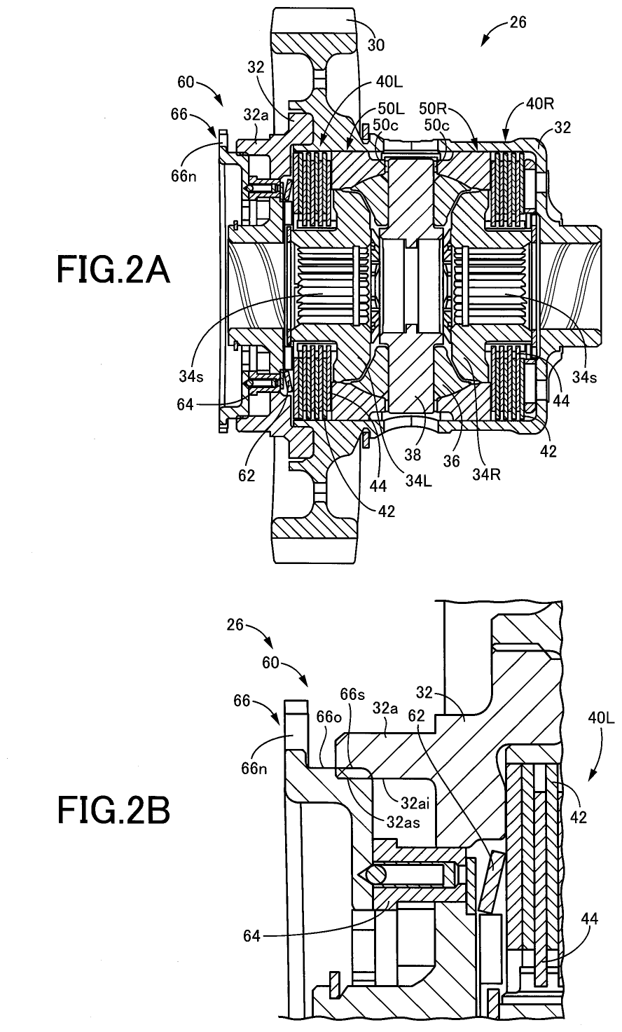

The differential side gears 34 includes a left side gear 34L and a right side gear 34R. Each of the differential-side gears 34 has spline teeth 34s (see FIG. 2A) formed on an inner circumferential surface of a through hole into which a corresponding one of the drive shafts 28 is fitted so as not to be rotatable relative to the corresponding one of the drive shafts 28. The differential pinions 36 meshes with the differential side gears 34. The differential pinions 36 is supported by the pinion shaft 38 so as to be rotatable relative to the pinion shaft 38. The differential side gears 34, to which the power inputted to the differential ring gear 30 is to be distributed, correspond to “pair of output rotary members” recited in the appended claims. The differential device 26 is a device in which a differential motion in the left and right differential side gears 34 is allowed in a differential state, and the left and right differential side gears 34 are at the same rotational speed in a non-differential state. That is, the differential side gears 34 are allowed to be rotated relative to each other in the differential state of the differential device 26, and the differential side gears 34 are to be rotated integrally with the differential ring gear 30 in the non-differential state of the differential device 26. The differential device 26 corresponds to “differential device” recited in the appended claims, and functions as, for example, a vehicle differential device.

FIGS. 2A and 2B are cross sectional views showing, by way of example, a construction of the differential device 26 according to the present embodiment of the invention, in a state before the drive shafts 28 are attached to the differential device 26. FIG. 2A shows an overall of the differential device 26, and FIG. 2B shows a part of the differential device 26, which is for applying a preload to a clutch as a differential limiting mechanism.

As shown in FIGS. 2A and 2B, the differential device 26 further includes left and right clutches 40 and left and right pressure rings 50, which are housed in the differential casing 32. The clutches 40 include a left clutch 40L and a right clutch 40R. The pressure rings 50 include a left pressure ring 50L and a right pressure ring 50R.

Each of the clutch 40 is interposed between the differential casing 32 and a corresponding one of the differential side gear 34. Each of the clutches 40 includes a plurality of outer plates 42 and a plurality of inner plates 44 that are alternately arranged. Outer peripheral portions of the respective outer plates 42 are spline-fitted to an inner circumferential surface of the differential casing 32. Inner peripheral portions of the respective inner plates 44 are spline-fitted to an outer circumferential surface of an end portion of a corresponding one of the differential side gears 34, which is remote from the pinion shaft 38. Each of the clutches 40 is a friction clutch configured to generate a frictional force with the outer plates 42 and the inner plates 44 being pressed against each other. Each of the clutches 40, serving as the mechanical differential limiting mechanism, is configured to limit the differential motion in the left and right differential side gears 34, namely, to limit rotations of the left and right differential side gears 34 relative to each other, by connecting a corresponding one of the differential side gears 34 with the differential casing 32, and corresponds to “clutch” recited in the appended claims.

Each of the pressure rings 50 has an outer circumferential surface spline-fitted to an inner circumferential surface of the differential casing 32, and a cam 50c which is provided in an axially end portion that is on side of the pinion shaft 38 and which is engaged with the pinion shaft 38. Each of the pressure rings 50 has another axially end portion which is remote from the pinion shaft 38 and which is in contact with a corresponding one of the clutches 40, such that each of the clutches 40 is sandwiched between a corresponding one of the pressure rings 50 and the differential casing 32. Each of the pressure rings 50, which is configured to cause a corresponding one of the clutches 40 to generate a torque that limits rotations of the left and right differential side gears 34 relative to each other, corresponds to “pressing member” recited in the appended claims.

In the differential device 26, when a rotation difference (rotational speed difference or torque difference) between the left and right differential side gears 34 becomes equal to or greater than a predetermined value, each of the pressure rings 50 is slid in a direction away from the pinion shaft 38. As a result, the clutches 40 are slip-engaged, and the differential motion of the differential device 26 is limited. The differential device 26 is a limited slip differential (LSD) including the clutches 40 each serving as the mechanical differential limiting mechanism. The rotational difference between the left and right differential side gears 34 is synonymous with the rotational difference between the left and right drive shafts 28 or the rotational difference between the left and right drive wheels 14.

A timing at which the differential limiting in the differential device 26 is to be operated, that is, the above-described predetermined value depends on, for example, the preload for pressing each of the clutches 40 in advance. For example, the differential restriction is performed from a region where the rotation difference between the left and right differential side gears 34 is smaller as the preload is larger.

The differential device 26 further includes an initial adjustment mechanism 60. The initial adjustment mechanism 60 includes a disc spring 62, a piston 64, and an adjustment dial 66.

The disc spring 62 is housed in the differential casing 32, and is configured to apply the preload to the clutch 40 (the left clutch 40L in the present embodiment), by cooperating with the pressure ring 50 (the left pressure ring 50L in the present embodiment) to sandwich the clutch 40 (the left clutch 40L in the present embodiment) therebetween, such that the clutch 40 (the left clutch 40L in the present embodiment) generates an initial torque that is an initial magnitude of the torque. The disc spring 62 corresponds to “elastic member”recited in the appended claims.

The differential casing 32 includes a cylindrical protrusion portion 32a which protrudes away from the clutch 40, namely, protrudes toward the adjustment dial 66, and which has an opening opening toward the adjustment dial 66. The piston 64 is provided radially inside the protrusion portion 32a. The piston 64 is disposed between the disc spring 62 and the adjustment dial 66, and is to be pressed by the adjustment dial 66 so as to press the disc spring 62. The piston 64 corresponds to “intermediate member” recited in the appended claims. The adjustment dial 66 is to press the disc spring 62 through the piston 64 such that the disc spring 62 applies the preload.

As best shown in FIG. 2B, the protrusion portion 32a has an inner circumferential surface 32ai provided with an internal thread 32 as, while the adjustment dial 66 has an outer circumferential surface 66o provided with an external thread 66s that is engaged with the internal thread 32as of the protrusion portion 32a. The adjustment dial 66 is screwed to the protrusion portion 32a of the differential casing 32. When an amount of screwing of the adjustment dial 66 in the protrusion portion 32a is increased, the disc spring 62 is pressed by the piston 64 whereby the preload applied by the disc spring 62 is generated. With the amount of screwing of the adjustment dial 66 in the protrusion portion 32a being increased, the preload applied by the disc spring 62 is increased. With the amount of screwing of the adjustment dial 66 in the protrusion portion 32a being reduced, the preload applied by the disc spring 62 is reduced. The adjustment dial 66, by which the preload applied by the disc spring 62 can be changed with the amount of screwing of the adjustment dial 66 being changed, corresponds to “adjuster” recited in the appended claims. Changing the preload applied by the disc spring 62 is synonymous with changing the initial torque of the clutch 40, namely, adjusting the initial torque of the clutch 40.

In this way, the differential device 26 has a construction in which the disc spring 62 disposed on one side of the clutch 40 can be pushed in from the outside of the differential casing 32. In the differential device 26, the initial torque of the clutch 40 is adjusted by a degree of pressing of the disc spring 62. The differential device 26 is an LSD capable of adjusting the initial torque of the clutch 40. The initial adjustment mechanism 60 is an initial-torque adjustment mechanism capable of adjusting the initial torque of the clutch 40.

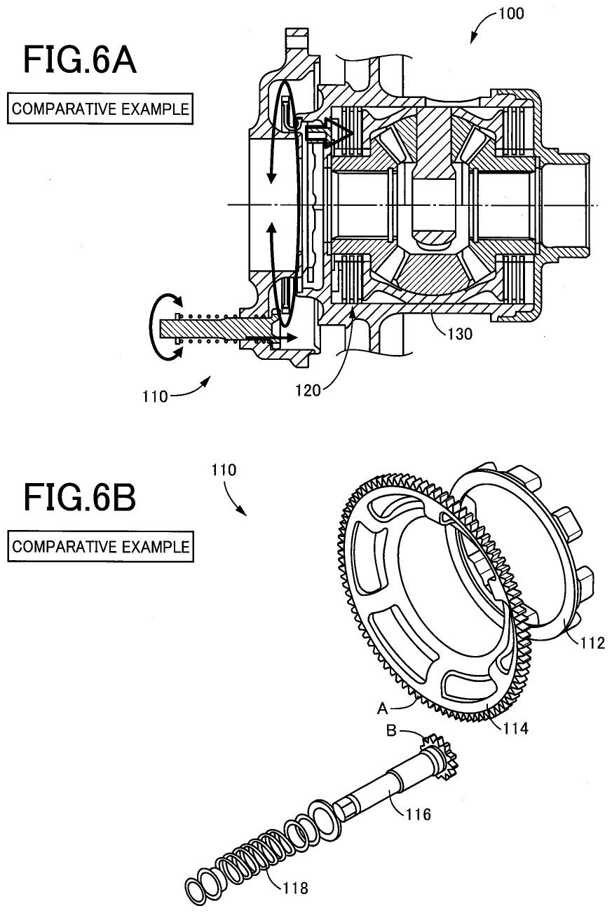

FIGS. 6A and 6B are views showing, by way of example, an adjustment of an initial torque in a differential device 100 of a comparative example. FIG. 6A schematically shows a construction of the differential device 100 provided with an initial-torque adjustment mechanism 110 in the comparative example. FIG. 6B schematically shows a construction of the initial-torque adjustment mechanism 110 in the comparative example. The differential device 100 functions as a known differential device. The differential device 100 includes a clutch 120 that functions as a mechanical differential limiting mechanism. The initial torque adjustment mechanism 110 includes a piston 112, an adjustment dial 114, an adjustment screw 116 and a spring 118. In the initial-torque adjustment mechanism 110, the adjustment dial 114 is rotated by rotating the adjustment screw 116. Thus, in the differential device 100, a force of the piston 112 pressing the clutch 120 is changed, and the initial torque of the clutch 120 is adjusted. When the initial torque of the clutch 120 is to be adjusted in the differential device 100, the adjustment dial 114 is rotated by operation of the adjustment screw 116 in a state in which a differential casing 130 is fixed. In the differential device 100, since the initial torque is adjusted from outside by using the adjustment screw 116, gears A and B for rotating the adjustment dial 114 are required for both the adjustment dial 114 and the adjustment screw 116. In the differential device 100, it is necessary that the gears A and B are engaged with each other when the initial torque is adjusted, and the gears A and B are not engaged with each other when the vehicle is running. Therefore, it is necessary to provide the spring 118 that allows the adjustment screw 116 to be separated from the adjustment dial 114, and to provide a slidable seal or the like that prevents oil leakage in a portion in which the adjustment screw 116 is slid relative to the differential casing 130. This complicates the structure for disengaging the gears A and B during running of the vehicle. Further, since a gear ratio of the gear A to the gear B is large, a large operation amount, i.e., a large number of rotations is required for the adjusting screw 116. In addition, it is difficult to visually recognize the adjustment amount of the initial torque. Thus, the adjustment screw 116 needs to be operated many times to adjust the initial torque.

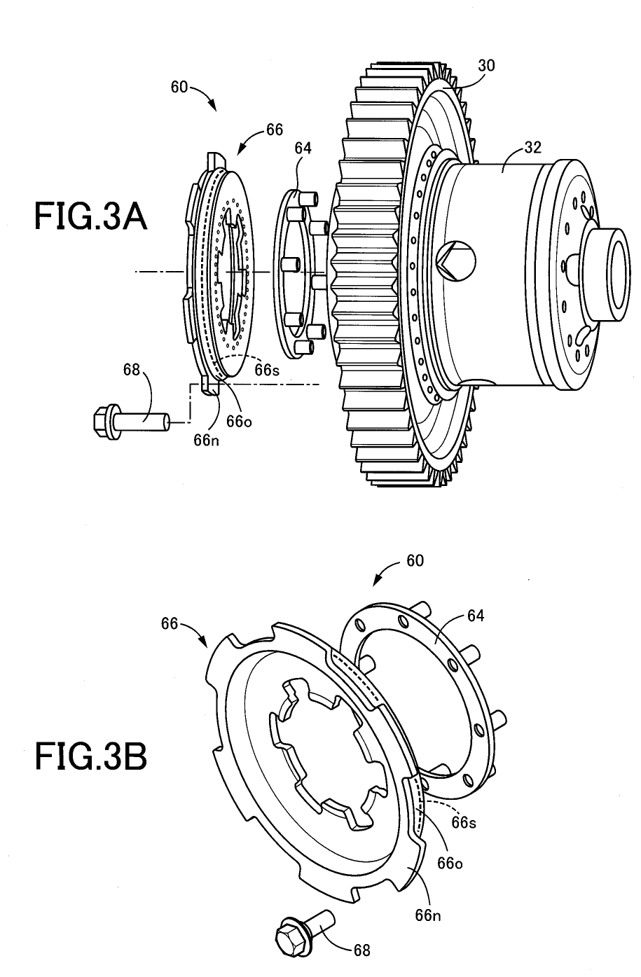

FIGS. 3A and 3B are views for showing, by way of example, the initial adjustment mechanism 60 in the present embodiment. FIG. 3A shows a relative positional relationship between the differential casing 32 and the initial adjustment mechanism 60 (without the disc spring 62 being shown). FIG. 3B is a perspective view of the initial adjustment mechanism 60 (without the disc spring 62 being shown).

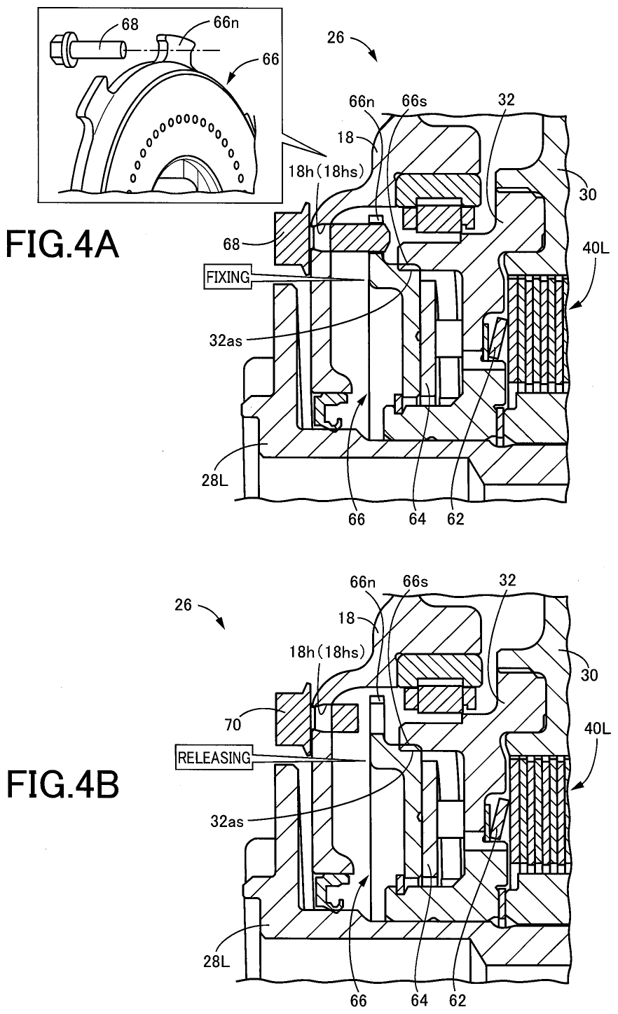

As shown in FIGS. 3A and 3B, the initial adjustment mechanism 60 further includes a fixture bolt 68. The fixture bolt 68 is a member for fixing the adjustment dial 66 to the housing 18 when the initial torque of the clutch 40 is to be adjusted. That is, the fixture bolt 68 is configured to fix the adjustment dial 66 to the housing 18 so as to make the adjustment dial 66 unrotatable relative to the housing 18, and to release fixing of the adjustment dial 66 to the housing 18. The fixture bolt 68 corresponds to “fixture” recited in the appended claims. As shown in FIG. 4A, the fixture bolt 68 is attached to the housing 18, thereby fixing the adjustment dial 66 to the housing 18 so as not to be rotatable relative to the housing 18. The fixing of the adjustment dial 66 to the housing 18 is released with the fixture bolt 68 being removed from the housing 18. The adjustment dial 66 includes a pawl portion 66n that is hooked on the fixture bolt 68. The pawl portion 66n is provided on the outer circumferential surface 66o of the adjustment dial 66 so as to protrude radially outwardly from the outer circumferential surface 66o. The pawl portion 66n consists of a plurality of pawls that are arranged at substantially equal intervals in the circumferential direction, for example. The adjustment dial 66 has an external thread 66s provided in a portion of the outer circumferential surface 66o, which is on side of the clutch 40. The pawl portion 66n is located in another portion of outer circumferential surface 66o, which is remote from the clutch 40. With the pawl portion 66n of the adjustment dial 66 being hooked on the fixture bolt 68, the adjustment dial 66 is fixed to the housing 18 through the fixture bolt 68, so as not to be rotatable relative to the housing 18.

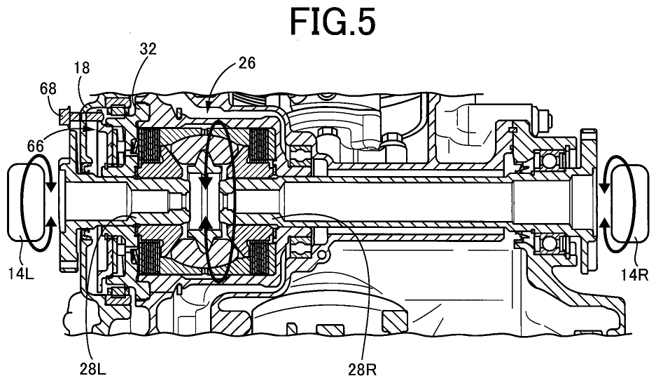

FIGS. 4A and 4B are views showing, by way of example, an initial-torque adjustment procedure in the differential device 26 according to the present embodiment. FIG. 4A shows a state of the initial adjustment mechanism 60 when the initial torque is being adjusted. FIG. 4B shows a state of the initial adjustment mechanism 60 when the vehicle 10 is running. FIG. 5 is a view showing, by way of example, the adjustment of the initial torque in the differential device 26 according to the present embodiment.

As shown in FIG. 4A, when the initial torque is being adjusted, the fixture bolt 68 is attached to the housing 18. As a result, the pawl portion 66n of the adjustment dial 66 is hooked on the fixture bolt 68, and the adjustment dial 66 is fixed to the housing 18 so as not to be rotatable relative to the housing 18. The housing 18 has a hole 18h in which the fixture bolt 68 is received. The hole 18h has an internal thread 18hs that is engaged with the fixture bolt 68. The differential device 26 may further include the non-rotatable member in the form of the housing 18 that houses the differential casing 32, the adjustment dial 66 and the like. The fixture bolt 68 has a length that allows the pawl portion 66n of the adjustment dial 66 to be engaged with the fixture bolt 68 in a state in which the fixture bolt 68 is received in the hole 18h of the housing 18. The fixture bolt 68 corresponds to “bolt” and “first bolt” recited in the appended claims.

As shown in FIG. 5, in the state in which the fixture bolt 68 is attached to the housing 18 and the adjustment dial 66 is fixed so as to be unrotatable relative to the housing 18, the left and right drive wheels 14 are rotated in the same direction at the same rotational speed, whereby the differential casing 32 is rotated integrally with the drive wheels 14. When the differential casing 32 is rotated, the external thread 66s of the adjustment dial 66, which is in a non-rotating state, is tightened or loosened relative to the differential casing 32. As a result, the pressing force of the piston 64 against the disc spring 62 is changed, so that the preload applied to the clutch 40 by the disc spring 62 is changed, and the initial torque of the clutch 40 is adjusted. The adjustment amount of the initial torque can be controlled by an rotational angle of the drive wheels 14.

When the initial torque of the clutch 40 is adjusted in the differential device 26, the differential casing 32 is rotated in a state in which the adjustment dial 66 is fixed. The differential device 26 has a structure in which the disc spring 62 disposed on one side of the clutch 40 can be pushed in from the outside. In the differential device 26, the adjustment dial 66 is fixed from the outside, and the drive wheels 14 are rotated to change the screwing amount of the adjustment dial 66 and the differential casing 32, thereby adjusting the initial torque. The differential device 26 is the LSD whose initial torque can be adjusted from the outside of the unit.

As shown in FIG. 4B, the differential device 26 further includes a release bolt 70 that is not engaged with the pawl potion 66n of the adjustment dial 66. When the vehicle is running, the release bolt 70 is received in the hole 18h of the housing 18. Thus, the adjustment dial 66 is rotatable relative to the housing 18 and is rotatable integrally with the differential casing 32, so that the initial torque of the clutch 40 is not changed. The hole 18h is also a hole into which the release bolt 70 is received. The release bolt 70, in place of the fixture bolt 68 as the first bolt, is to be received in the hole 18h of the housing 18, and has a length shorter than the length of the fixture bolt 68 such that the pawl portion 66n of the adjustment dial 66 is not engaged with the release bolt 70 when the release bolt 70 is received in the hole 18h. The release bolt 70 corresponds to “second bolt”recited in the appended claims.

In a normal state in which the initial torque of the clutch 40 is not changed or not adjusted, the release bolt 70 is attached to the housing 18. When the initial torque is to be changed or adjusted, the release bolt 70 is replaced with the fixture bolt 68.

This enables change or adjustment of the initial torque. After the initial torque is changed or adjusted, the fixture bolt 68 is changed to the release bolt 70. Thus, when the initial torque is not change or not adjusted, the fixing of the adjustment dial 66 to the housing 18 through the fixture bolt 68 is released.

In the differential device 26 of the present embodiment, the gears A and B (see FIGS. 6A and 6B), which are required in the differential device 100 of the comparative example, are not required, and the structure is simplified. Further, in the differential device 26 of the present embodiment, mass-produced bolts can be used as the fixture bolt 68 and the release bolt 70. Moreover, in the differential device 26 of the present embodiment, the initial torque of the clutch 40 can be adjusted by rotating the drive wheels 14, and the initial torque can be easily changed.

As described above, according to the present embodiment, the differential device 26 includes the clutch 40, the pressure ring 50, the disc spring 62, the adjustment dial 66 and the fixture bolt 68. The clutch 40 is a mechanical differential limiting mechanism. The pressure ring 50 is a member that presses the clutch 40 so as to generate the torque that limits the differential motion in the clutch 40. The disc spring 62 is a member configured to apply the preload to the clutch 40 so as to generate the initial torque. The adjustment dial 66 is a member that is screwed to the differential casing 32, presses the disc spring 62, and changes the preload with the amount of screwing being changed. The fixture bolt 68 is a member configured to fix the adjustment dial 66 to the housing 18 so as not to be rotatable relative to the housing 18, and to release the fixing. Accordingly, in a state in which the adjustment dial 66 is fixed through the fixture bolt 68 so as to be unrotatable relative to the housing 18, the differential casing 32 is rotated integrally with the differential side gears 34 by, for example, the pair of differential side gears 34 being rotated in the same direction at the same rotational speed. When the differential casing 32 is rotated, the external thread 66s of the adjustment dial 66 in a non-rotating state is tightened or loosened relative to the differential casing 32, so that the preload applied to the clutch 40 by the disc spring 62 is changed, and the initial torque is adjusted. The amount of adjustment of the initial torque can be controlled by the amount of rotation of the differential side gears 34, that is, the rotation angle of the drive wheels 14. When the initial torque is not be changed or not be adjusted, the fixing of the adjustment dial 66 by the fixture bolt 68 is released. Therefore, the differential device 26 has a simplified construction required for adjusting the initial torque of the clutch 40, and makes it possible to easily adjust the initial torque.

According to the present embodiment, the differential casing 32 has the protrusion portion 32a which protrudes toward the adjustment dial 66 and which has the opening opening toward the adjustment dial 66. The protrusion portion 32a has the inner circumferential surface 32ai provided with the internal thread 32as. The adjustment dial 66 has the outer circumferential surface 66o provided with the external thread 66s that is engaged with the internal thread 32as of the protrusion portion 32a. The differential device 26 further includes the piston 64 which is provided radially inside the protrusion portion 32a and which is to be pressed by the adjustment dial 66 so as to press the disc spring 62. Thus, it is possible to appropriately control the adjustment amount of the initial torque by the rotation angle of the drive wheels 14.

Further, according to the present embodiment, the adjustment dial 66 has the pawl portion 66o which protrudes radially outwardly from the outer circumferential surface 66n and which is engaged with the fixture bolt 68. Accordingly, the adjustment dial 66 is fixed to the housing 18 through the fixture bolt 68 so as not to be rotatable relative to the housing 18 with the pawl portion 66n being engaged with the fixture bolt 68.

According to the present embodiment, the differential device 26 further includes the housing 18 as the non-rotatable member. The housing 18 houses the differential casing 32 and the adjustment dial 66, and has the hole 18h provided with the internal thread 18hs. The fixture bolt 68 has a length that allows the pawl portion 66n of the adjustment dial 66 to be engaged with the fixture bolt 68 when the fixture bolt 68 is received in the hole 18h of the housing 18. Thus, when the initial torque of the clutch 40 is to be adjusted, the fixture bolt 68 is attached to the housing 18, and the adjustment dial 66 is fixed to the housing 18 so as not to be rotatable relative to the housing 18.

Further, according to the present embodiment, the release bolt 70, in place of the fixture bolt 68, is to be received in the hole 18h of the housing 18, and has a length shorter than the length of the fixture bolt 68 such that the pawl portion 66n of the adjustment dial 66 is not engaged with the release bolt 70 when the release bolt 70 is received in the hole 18h. Thus, when the initial torque of the clutch 40 is not to be adjusted, the release bolt 70 is attached to the housing 18 in place of the fixture bolt 68, and the fixing of the adjustment dial 66 to the housing 18 with the fixture bolt 68 being released.

Although the embodiment of the present invention has been described in detail with reference to the drawings, the present invention is also applicable to other aspects.

For example, in the above-described embodiment, when the initial torque of the clutch 40 is changed or adjusted, the differential casing 32 is rotated integrally with the drive wheels 14 by rotating the left and right drive wheels 14 in the same direction at the same rotational speed, but the present invention is not limited to this aspect. Since the differential casing 32 may be rotated in a state in which the adjustment dial 66 is fixed to the housing 18 so as not to be rotatable relative to the housing 18, the differential casing 32 may be rotated by rotating one of the left and right drive wheels 14 in a state in which the other drive wheel is stopped without rotation, for example.

In the above-described embodiment, the fixture that fixes the adjustment dial 66 to the housing 18 so as not to be rotatable relative to the housing 18 and releases the fixing of the adjustment dial 66 to the housing 18 is the fixture bolt 68 that is screwed into the hole 18h. However, the fixture may be a simple rod without a screw, for example.

In the above-described embodiment, when the initial torque of the clutch 40 is not changed or not adjusted, the release bolt 70 is attached to the housing 18 in place of the fixture bolt 68, but the present invention is not limited to this aspect. For example, when the initial torque of the clutch 40 is not changed or not adjusted, a lid or the like that closes the hole 18h may be attached to the hole 18h, in place of the fixture.

In the above-described embodiment, the differential device 26 that distributes the inputted power to the left and right drive wheels 14 is shown as the differential device to which the present disclosure is applied. The differential device to which the present invention is applied may be, for example, a center differential device for absorbing a difference in rotation between front and rear wheels in a front/rear wheel drive vehicle.

The above description is merely an embodiment, and the present invention can be implemented in modes with various modifications and improvements based on the knowledge of those skilled in the art.

### DESCRIPTION OF REFERENCE SIGNS

18: housing (non-rotary member)
18h: hole
18hs: internal thread
26: differential device
30: differential ring gear (input rotary member)
32: differential casing (input rotary member, casing)
32a: protrusion portion
32ai: inner circumferential surface
32as: internal thread
34 (34L, 34R): differential side gear (output rotary member)
40 (40L, 40R): clutch (differential limiting mechanism)
50 (50L, 50R): pressure ring (pressing member)
62: disc spring (elastic member)
64: piston (intermediate member)
66: adjustment dial (adjuster)
66n: pawl portion
66o: outer circumferential surface
66s: external thread
68: fixture bolt (fixture, bolt)
70: release bolt (second bolt)

What is claimed is:

1. A differential device comprising:
a casing;
an input rotary member which is fixed to the casing and to which a power is to be inputted;
a pair of output rotary members to which the power inputted to the input rotary member is to be distributed, such that the pair of output rotary members are allowed to be rotated relative to each other in a differential state of the differential device, and such that the pair of output rotary members are to be rotated integrally with the input rotary member in a non-differential state of the differential device;
a clutch which is housed in the casing, and which is configured to limit rotations of the pair of output rotary members relative to each other, by connecting the pair of output rotary members with the casing;
a pressing member which is housed in the casing, and which is configured to press the clutch so as to cause the clutch to generate a torque that limits the rotations of the pair of output rotary members relative to each other;
an elastic member which is housed in the casing, and which is configured to apply a preload to the clutch such that the clutch generates an initial torque that is an initial magnitude of the torque;
an adjuster which is screwed to the casing, and which is configured to press the elastic member so as to cause the elastic member to apply the preload to the clutch and to change the preload with an amount of screwing of the adjuster being changed; and
a fixture which is configured to fix the adjuster to a non-rotatable member so as to make the adjuster unrotatable relative to the non-rotatable member, and to release fixing of the adjuster to the non-rotatable member.

2. The differential device according to claim 1,
wherein the casing includes a protrusion portion which protrudes toward the adjuster and which has an opening opening toward the adjuster,
wherein the protrusion portion has an inner circumferential surface provided with an internal thread,
wherein the adjuster has an outer circumferential surface provided with an external thread that is engaged with the internal thread of the protrusion portion, and
wherein the differential device further comprises an intermediate member which is provided radially inside the protrusion portion and which is to be pressed by the adjuster so as to press the elastic member.

3. The differential device according to claim 1,
wherein the adjuster includes a pawl portion which protrudes radially outwardly from an outer circumferential surface of the adjuster and which is engaged with the fixture.

4. The differential device according to claim 3,
wherein the differential device further comprises a housing as the non-rotatable member,
wherein the housing houses the casing and the adjuster, and has a hole provided with an internal thread,
and wherein the fixture is a bolt having a length that allows the pawl portion of the adjuster to be engaged with the bolt when the bolt is received in the hole of the housing.

5. The differential device according to claim 4,
wherein the differential device further comprises a second bolt in addition to the bolt as a first bolt, and
wherein the second bolt, in place of the first bolt, is to be received in the hole of the housing, and has a length shorter than the length of the first bolt such that the pawl portion of the adjuster is not engaged with the second bolt when the second bolt is received in the hole.
